(19) United States
(12) Patent Application Publication
(10) Pub. No.: US 2009/0021094 A1
(43) Pub. Date: Jan. 22, 2009

(54) MOTOR, AND ROTOR, AND MANUFACTURING METHOD FOR THE ROTOR, AND A MOTOR PROVIDED WITH THE ROTOR

(75) Inventors: Iwao TAKIMOTO, Nagano (JP); Masashi TAKAHASHI, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/168,604

(22) Filed: Jul. 7, 2008

(30) Foreign Application Priority Data
Jul. 6, 2007 (JP) JP2007-177869
Jul. 6, 2007 (JP) JP2007-177870

(51) Int. Cl. H02K 21/16; H02K 15/03

(52) U.S. Cl. 310/156.12; 29/598

(57) ABSTRACT

A motor may include a stator provided with a plurality of salient poles and coils and a rotor provided with a permanent magnet. The stator is a stator in a concentrated winding system and the permanent magnet is structured of two magnetic poles which are provided with one “S”-pole and one “N”-pole. Each of the two magnetic poles is formed in an angular range of from 135° to 180° and the two magnetic poles are formed in the same angular range. Further, a rotor may include a protective layer having a fiber sheet hardened with resin for covering an outer peripheral side of a permanent magnet. The fiber sheet may include a first fiber sheet whose width dimension is narrower and a second fiber sheet whose width dimension equal to or more than that of the permanent magnet and the first fiber sheet and the second fiber sheet are wound around the outer peripheral side of the permanent magnet.

### CROSS REFERENCE TO RELATED APPLICATION

The present invention claims priority under 35 U.S.C. §119 to Japanese Application No. 2007-177869 filed Jul. 6, 2007 and Japanese Application No. 2007-177870 filed Jul. 6, 2007, both of which are incorporated herein by reference.

### FIELD OF THE INVENTION

At least an embodiment of the present invention may relate to a rotor provided with a permanent magnet, a brushless motor provided with a stator for generating a rotating magnetic field to the rotor, an inner type of rotor which is provided with a permanent magnet on an outer peripheral side of a rotor shaft, a manufacturing method for the rotor, and a motor provided with the rotor.

### BACKGROUND OF THE INVENTION

A brushless motor is provided with a stator in which coils are wound around a plurality of salient poles protruding radially and a rotor having a permanent magnet which faces tip ends of the salient poles through a gap. An induced voltage waveform generated in the coils is detected to control energization to the coils on the basis of the induced voltage waveform and an optimal rotating magnetic field is generated to the rotor. Therefore, when the waveform or peak voltage values of the induced voltage are not accurate, rotation cannot be controlled accurately.

In order to prevent the above-mentioned problem, the following structures have been conventionally proposed. For example, a stator with a distributed winding system in which previously wound coils are mounted on pole teeth is utilized and their winding patterns are adjusted to make the induced voltage waveform bring close to a sine wave. Alternatively, when a stator with a concentrated winding system in which coils are directly wound around a plurality of salient poles respectively is adopted, the number of poles of a permanent magnet is increased to 16 (see, for example, Japanese Patent Laid-Open No. 2006-187189).

An inner rotor-type motor is commonly provided with a rotor having a permanent magnet on an outer peripheral side of a rotor shaft and a stator for generating a rotating magnetic field to the rotor. In the motor as described above, when the rotor is rotated at a high speed, a centrifugal force is applied to the permanent magnet which is disposed on the outer periphery of the rotor shaft and thus the permanent magnet may be damaged and scattered. In order to prevent this problem, as shown in FIG. 9, a structure has been proposed in which a protective cover 1003 obtained by heat-curing of carbon prepreg is fitted or press-fitted to the outer periphery of a ring-shaped permanent magnet 1002 which is disposed on an outer periphery of the rotor shaft 1001 (see, Japanese Patent Laid-Open No. Hei 8-107641).

However, in a case where a concentrated winding system is adopted in the motor described in the former Patent Reference for improving motor characteristics, when a rotor is formed of a two-pole structure for simplifying a motor structure and its manufacturing steps, for using divided permanent magnets as a permanent magnet, and for reducing the number of poles to reduce loss, a satisfactory induced voltage waveform can not be obtained.

Further, in the rotor 1000 described in the latter Patent Reference, firstly, carbon prepreg is wound around a cylindrical dummy member or the like and heat-cured to form a pipe-shaped protective cover 1003. After that, the protective cover 1003 is detached from the dummy member and then, the protective cover 1003 is fitted or press-fitted to the outer peripheral face of the permanent magnet 1002. Therefore, its manufacturing efficiency is not satisfactory. Further, in the rotor 1001 described in the latter Patent Reference, in order to bring the protective cover 1003 to tightly contact with the permanent magnet 1002, a finishing processing for enhancing an inner diameter accuracy of the protective cover 1003 is required after the protective cover 1003 is detached from the dummy member. This step also causes to decrease its manufacturing efficiency.

### SUMMARY OF THE INVENTION

In view of the problems described above, at least an embodiment of the present invention may advantageously provide a motor which is capable of obtaining a satisfactory induced voltage waveform even when a stator in a concentrated winding system and a rotor with two poles are used.

Further, in view of the problems described above, at least another embodiment of the present invention may advantageously provide a rotor which is capable of preventing from scattering of a permanent magnet without reducing its manufacturing efficiency, a manufacturing method for the rotor, and a motor provided with the rotor.

Thus, according to at least an embodiment of the present invention, there may be provided a motor including a stator, which is provided with a plurality of salient poles protruding radially and coils wound around a plurality of the salient poles, and a rotor which is provided with a permanent magnet facing tip ends of the salient poles through a gap. The stator is a stator in a concentrated winding system in which the coils are respectively wound around a plurality of the salient poles, and the permanent magnet is structured of two magnetic poles which are provided with one “S”-pole and one “N”-pole. Each of the two magnetic poles is formed in an angular range of from 135° (included) to 180° (included) and the two magnetic poles are formed in the same angular range each other.

In accordance with at least an embodiment of the present invention, a stator in a concentrated winding system in which coils are respectively wound around a plurality of salient poles is used. Therefore, an electric resistance can be reduced by shortening of the coil ends and a motor characteristic can be improved. Further, connection of the coils is easy in the stator in a concentrated winding system. Further, the rotor in the embodiment of the present invention is provided with two-magnetic poles and each of the two magnetic poles is formed in an angular range of from 135° to 180° and the two magnetic poles are formed in a sane angular range each other and thus a region in the circumferential direction where the magnetic pole is not formed is narrow. Therefore, a drop of the peak voltage in an induced voltage waveform can be suppressed within an acceptable limit of 15% and thus the induced voltage waveform can be treated in the same way as a sine wave. Accordingly, even when a stator in a concentrated winding system and a rotor with two poles are used, rotation control of the motor can be performed securely and torque ripple and iron loss can be reduced.

At least an embodiment of the present invention may be applied to a motor in which a stator is structured with six poles, in other words, provided with six salient poles. According to the structure as described above, iron loss can be reduced, and reduction of torque, increase of cogging torque and reduction of utilization efficiency of magnetic flux of the permanent magnet can be prevented. In other words, when the number of poles is set to be more than six, iron loss becomes larger and, on the contrary, when the number of poles is set to be less than six, reduction of torque, increase of cogging torque, reduction of utilization efficiency of magnetic flux of the permanent magnet may occur. However, when the number of poles is set to be six, the above-mentioned problems can be avoided.

In accordance with at least an embodiment of the present invention, each of the two magnetic poles is formed in an angular range from 150° (included) to 180° (included). According to this structure, since the induced voltage waveform becomes almost a sine wave, a drop of its peak voltage can be suppressed within an acceptable limit of 10%. Therefore, even when a stator in a concentrated winding system and a rotor with two poles are used, rotation control of a motor can be further securely performed.

In accordance with at least an embodiment of the present invention, the permanent magnet is comprised of two divided permanent magnets which are divided into two poles in a circumferential direction. A ring-shaped permanent magnet may be damaged by a centrifugal force at a high-speed rotation and thus an expensive sleeve made of titanium is required to cover on its outer peripheral side to apply a pressure on an inner side. However, according to this embodiment, since the divided permanent magnets are used, the permanent magnets may not be damaged by a centrifugal force even at a high-speed rotation. Therefore, since an expensive sleeve made of titanium is not required, cost can be reduced.

In accordance with at least an embodiment of the present invention, the two divided permanent magnets are formed in a circular arc shape whose circular arc angle is less than 180°. According to this embodiment, even when forming accuracy of two divided permanent magnets is provided with dispersion, the divided permanent magnets can be held in the rotor securely.

In this case, it is preferable that the rotor is formed with a positioning part with which end faces in a circumferential direction of the two divided permanent magnets abut. According to this structure, the two divided permanent magnets can be held in the rotor with a high degree of positional accuracy. Further, even when the rotor is rotated at a high speed, the divided permanent magnets do not shift in the circumferential direction.

In accordance with at least an embodiment of the present invention, the rotor is provided with a rotor shaft which holds the two divided permanent magnets on an outer peripheral face of the rotor shaft, and the outer peripheral face of the rotor shaft is formed with two recessed parts for fitting the two divided permanent magnets, and a portion of the rotor shaft which is sandwiched by the two recessed parts is formed as the positioning part, and both end faces in the circumferential direction of the positioning part are abutted with end faces in the circumferential direction of the two divided permanent magnets. In this case, it is preferable that a depth dimension of the recessed part is substantially equal to a thickness dimension of the two divided permanent magnets, and a shallow recessed part is formed in the whole circumferential direction on both sides in an axial direction of the recessed part so as to be shallower than the recessed part, and a protective layer for protecting outer peripheral faces of the two divided permanent magnets is formed over the whole shallow recessed part. According to this structure, the protective layer can be formed in a state that the two divided permanent magnets are embedded in the rotor shaft and thus fixing and prevention of scattering of the divided permanent magnets can be performed securely.

In accordance with at least an embodiment of the present invention, each of the two divided permanent magnets is provided with end faces in the circumferential direction which are located on the same plane. According to this structure, the divided permanent magnets can be formed efficiently. Further, the divided permanent magnets can be placed in a stable state where end faces of their end portions are directed in a downward direction and thus the divided permanent magnets can be easily handled in manufacturing steps. Further, in the state that the two divided permanent magnets are disposed on the rotor, the end faces of the two divided permanent magnets are parallel to each other and thus the two divided permanent magnets can be held on the rotor with a high degree of positional accuracy.

In accordance with at least an embodiment of the present invention, the two divided permanent magnets are magnetized over the whole circumferential direction.

In accordance with at least an embodiment of the present invention, an outer peripheral side or an outer peripheral face of the permanent magnet is covered with a protective layer. According to this structure, even when the rotor is rotated at a high speed, for example, the number of revolutions is tens of thousands revolutions per minute, the permanent magnet is not damaged by a centrifugal force and thus the permanent magnet is not scattered.

In this case, it is preferable that the protective layer is structured so that a fiber sheet is hardened with resin. When the above-mentioned protective layer is provided, an expensive protective cover such as a sleeve made of titanium is not required.

Further, according to at least another embodiment of the present invention, there may be provided a rotor including a rotor shaft, a permanent magnet which is held on an outer periphery of the rotor shaft, and a protective layer having a fiber sheet hardened with resin for covering an outer peripheral side of the permanent magnet. The fiber sheet includes a first fiber sheet whose width dimension is narrower than a width dimension in an axial direction of the permanent magnet, and a second fiber sheet which is provided with a width dimension equal to or more than a width dimension in the axial direction of the permanent magnet, and the first fiber sheet and the second fiber sheet are wound around the outer peripheral side of the permanent magnet so as to overlap each other.

In accordance with at least the embodiment of the present invention described above, a fiber sheet is directly wound around the outer peripheral side of the permanent magnet to form a protective layer for preventing from scattering of the permanent magnet. Therefore, different from the conventional case, a manufacturing step can be eliminated in which a pipe-shaped protective cover is fitted or press-fitted to the outer periphery of the permanent magnet after the protective cover has been formed by using a cylindrical dummy member. Further, finish machining for enhancing accuracy of the inner diameter of the protective cover is not required and thus efficiency of manufacturing the rotor can be enhanced. Further, according to at least this embodiment of the present invention, the protective cover is formed of the first fiber sheet and the second fiber sheet having different width dimensions from each other which are wound around the outer peripheral side of the permanent magnet and thus its strength is high. Therefore, scattering of the permanent magnet can be prevented securely. In addition, the protective layer in this embodiment provides an effect to securely fix the permanent magnet to the rotor shaft.

In accordance with at least an embodiment of the present invention, the first fiber sheet is wound around so that the first fiber sheet is partially overlapped each other in a widthwise direction. According to this structure, even when a pin hole or the like is occurred in the first fiber sheet, the first fiber sheet is partially overlapped each other and thus the first fiber sheet can be prevented from splitting from the pinhole as the starting point.

In accordance with at least an embodiment of the present invention, the first fiber sheet is wound around in a spiral manner. According to this structure, the first fiber sheet can be efficiently wound around in the state that the first fiber sheet is partially overlapped in the widthwise direction.

In accordance with at least an embodiment of the present invention, a winding end face of at least one of the first fiber sheet and the second fiber sheet, which is disposed on an upper side, is directed to a direction opposite to a rotating direction of the rotor shaft. According to this structure, when the rotor is rotated, a winding end of the fiber sheet can be prevented from being rolled up by a wind pressure.

In accordance with at least an embodiment of the present invention, the first fiber sheet is wound around an inner side and the second fiber sheet is wound around on an outer side of the first fiber sheet. According to this structure, the extent where edge portions in the widthwise direction of the fiber sheet are exposed is reduced and thus a space for gas or the like entering into the inside is narrow. Therefore, the fiber sheet can be prevented from being rolled up by, for example, a wind pressure. Further, unevenness in the outer peripheral face of the protective layer can be eliminated.

In accordance with at least an embodiment of the present invention, the second fiber sheet is wound around on an inner side and the first fiber sheet is wound around on an outer side of the second fiber sheet.

In accordance with at least an embodiment of the present invention, the rotor shaft is formed with a pair of large diameter parts at both end sides so as to interpose a holding portion of the permanent magnet, and a winding face for the fiber sheet of the protective layer is located on an inner side in a radial direction with respect to outer peripheral faces of a pair of the large diameter parts. In the rotor having the structure as described above, the conventional protective cover cannot be fitted to the rotor shaft but, according to this embodiment, the protective cover can be fitted to the rotor.

In accordance with at least an embodiment of the present invention, the second fiber sheet is provided with a width dimension which is substantially equal to a separated dimension of a pair of the large diameter parts. According to this embodiment, the protective layer can be easily formed between the large diameter parts.

In accordance with at least an embodiment of the present invention, the permanent magnet is fitted into a recessed part which is formed on an outer peripheral face of the rotor shaft. According to this embodiment, displacement in an axial direction of the permanent magnet can be restricted.

In accordance with at least an embodiment of the present invention, a depth dimension of the recessed part is substantially equal to a thickness dimension of the permanent magnet. According to this structure, the protective layer can be formed in the state that the permanent magnet is completely embedded in the recessed part and thus fixing and scattering prevention of the permanent magnet can be performed securely.

In accordance with at least an embodiment of the present invention, a shallow recessed part which is shallower than the recessed part is formed on both sides in the axial direction of the recessed part over the whole circumferential direction, and the first fiber sheet and the second fiber sheet are wound around the whole shallow recessed part so as to cover the outer periphery of the permanent magnet. According to this structure, the first fiber sheet and the second fiber sheet which are the protective layers can cover the outer periphery of the permanent magnet so as to bury the recessed part without protruding from the rotor.

In accordance with at least an embodiment of the present invention, the first fiber sheet and the second fiber sheet include carbon fiber.

In accordance with at least an embodiment of the present invention, a fiber sheet in which all fibers are arranged in one direction in the rotating direction of the rotor shaft or a fiber sheet in which carbon fibers are woven in the transversal and longitudinal directions in a mesh-like shape is used as the first fiber sheet and the second fiber sheet. In this case, it is preferable to use an inexpensive fiber sheet in which all fibers are arranged in one direction. Fibers of the latter fiber sheet are knit in the transversal and longitudinal directions and thus the fibers are crossed while being curved. Therefore, when the latter fiber sheet is going to be wound around the outer peripheral face of the permanent magnet, the fiber sheet may be extended in the circumferential direction to occur a hole. Further, in the state that the latter fiber sheet has been wound around the outer peripheral face of the permanent magnet and the resin has been hardened, when the permanent magnet is damaged to be going to be scattered on the outer side, the latter fiber sheet may be easily extended on the outer side in the radial direction, that is, strength of the latter fiber sheet to the extension is low. On the contrary, the former fiber sheet does not occur the problem described above. Further, in the case of the former fiber sheet, when the fibers are overlapped each other in the respective layers, splitting may occur between fibers. In the case of the latter fiber sheet, the fibers may be easily broken at portions where the fibers in the transversal direction and the fibers in the longitudinal direction are crossed each other. However, these problems can be solved by winding of the fiber sheet several times.

In accordance with at least an embodiment of the present invention, each of the first fiber sheet and the second fiber sheet is comprised of prepreg in which the resin is impregnated. When the prepreg is used, resin has been impregnated in the fiber sheet previously. Therefore, the protective layer can be formed by means of that the fiber sheet is heated after it has been wound around, and adhesivity with the permanent magnet can be enhanced.

Further, according to at least another embodiment of the present invention, there may be provided a manufacturing method for a rotor, which is provided with a rotor shaft and a permanent magnet held on an outer periphery of the rotor shaft, including a first fiber sheet winding step in which a first fiber sheet whose width dimension is narrower than a width dimension in an axial direction of the permanent magnet is wound around an outer peripheral side of the permanent magnet, and a second fiber sheet winding step in which a second fiber sheet whose width dimension is equal to or more than the width dimension in the axial direction of the permanent magnet is wound around the outer peripheral side of the permanent magnet, thereby the outer peripheral side of the permanent magnet is covered with the protective layer in which the fiber sheets are hardened with resin.

In accordance with at least an embodiment of the present invention, prepreg in which resin is impregnated is used for the first fiber sheet and the second fiber sheet, and a thermosetting step in which resin included in the prepreg is heated to be hardened is performed after the first fiber sheet winding step and the second fiber sheet winding step.

The rotor to which at least an embodiment of the present invention is applied may be used in a motor and the motor may be provided with the rotor in accordance with the above-mentioned embodiments and a stator for generating a rotating magnetic field to the rotor.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a plan view showing a structure of a motor in accordance with an embodiment of a first invention.

FIG. 2(a) is a longitudinal sectional view showing a rotor in accordance with an embodiment of the first invention and FIG. 2(b) is an “A- A′” cross-sectional view in FIG. 2(a).

FIGS. 3(a) through 3(f) are side views showing steps of a manufacturing method for a rotor in accordance with an embodiment of the first invention.

FIGS. 4(a) and 4(b) are explanatory views showing a fiber sheet which is used in the manufacturing method shown in FIGS. 3(a) through 3(f).

FIGS. 5(a), 5(b) and 5(c) are waveform views showing an induced voltage when a circular arc angle of a divided permanent magnet is changed to 120°, 150° and 180° in a motor in accordance with an embodiment of the first invention, and FIG. 5(d) is a graph showing a relationship between the circular arc angle of the divided permanent magnet and a drop ratio of a peak voltage in the induced voltage waveform.

FIG. 6(a) is a cross-sectional view showing an improved example of a rotor which is used in a motor in accordance with an embodiment of the first invention and FIG. 6(b) is a perspective view showing a divided permanent magnet.

FIG. 7 is a plan view showing a structure of a motor in accordance with an embodiment of a second invention.

FIG. 8(a) is a longitudinal sectional view showing a rotor in accordance with an embodiment of the second invention and FIG. 8(b) is an “A-A′” cross-sectional view in FIG. 8(a).

FIG. 9 is a perspective view showing a conventional rotor relating to the second invention.

### DETAILED DESCRIPTION OF THE PREFERRED EMBODIMENTS

### First Embodiment

A motor in accordance with a first embodiment of the present invention will be described below with reference to the accompanying drawings. The first embodiment is an embodiment for describing a first invention.

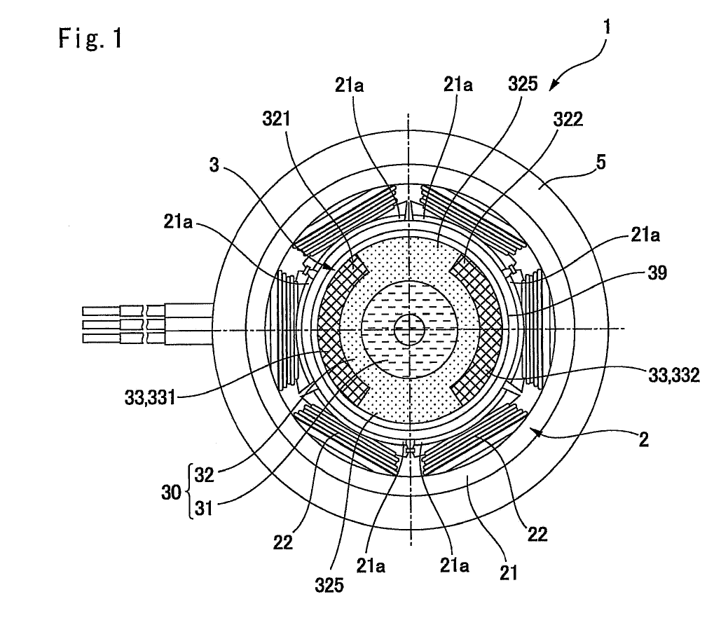

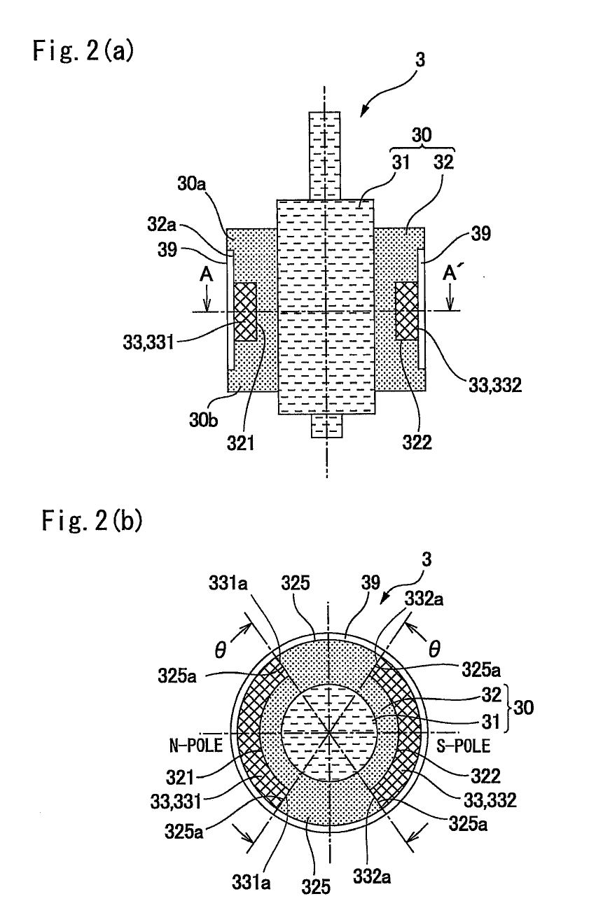

FIG. 1 is a plan view showing a structure of a motor in accordance with the first embodiment of the present invention. FIG. 2(a) is a longitudinal sectional view showing a rotor in accordance with the first embodiment and FIG. 2(b) is an “A-A′” cross-sectional view in FIG. 2(a).

As shown in FIG. 1, a motor 1 in the first embodiment is an inner rotor-type motor in which a rotor 3 is disposed on an inner side of a ring-shaped stator 2. The stator 2 and the rotor 3 are accommodated within a case 5.

The stator 2 includes a ring-shaped stator core 21. The stator core 21 is provided with six salient poles 21a protruding on an inner side in a radial direction. A coil 22 is wound around the respective six salient poles 21a. In this embodiment, the coil 22 is provided for three phases and the coil 22 for the respective phases is wound directly around a plurality of the respective corresponding salient poles 21a. In this manner, the stator 2 is structured as a concentrated winding system of stator with six poles and generates a rotating magnetic field to the rotor 3. In accordance with an embodiment, the ring-shaped stator core 21 may be structured such that cores which have been divided into one pole each are assembled in a ring shape.

As shown in FIG. 1 and FIGS. 2(a) and 2(b), the rotor 3 includes a rotor shaft 30 and a permanent magnet 33 which is held on an outer peripheral face of the rotor shaft 30. The outer peripheral face of the permanent magnet 33 faces the tip ends of the salient poles 21a which are provided in the stator 2 through a predetermined gap space. A rare earth magnet such as a neodymium magnet or a ferrite magnet may be used for the permanent magnet 33 and, in this embodiment, a neodymium magnet is used.

The rotor shaft 30 includes a shaft body 31 whose both ends are supported by bearings (not shown) or the like and a yoke part 32 which is formed on an outer periphery of the shaft body 31.

In this embodiment, the permanent magnet 33 is structured of two divided permanent magnets 331 and 332 whose cross section is in a circular arc-shape. An outer side of one of the divided permanent magnets 331 and 332 is magnetized in an “N”-pole and an outer side of the other of the permanent magnets 331 and 332 is magnetized in an “S”-pole.

As shown in FIG. 2(a), an outer peripheral face of the rotor shaft 30 (outer peripheral face of the yoke part 32) is formed with a first recessed part 32a which is extended over a wide area in an axial direction and over the entire circumferential direction. The first recessed part 32a is formed to be shallower than second recessed parts which will be described below. Large diameter parts 30a and 30b having the same diameter as each other are formed at both ends in the axial direction of the yoke part 32.

The second recessed parts 321 and 322 are formed at a substantially center portion in the axial direction of the first recessed part 32a over a predetermined angular range in the circumferential direction so as to be deeper than the first recessed part 32a. Two portions sandwiched by the second recessed parts 321 and 322 in the circumferential direction are respectively formed as a positioning part 325. In other words, the divided permanent magnets 331 and 332 are respectively fixed to the second recessed parts 321 and 322 in a fitted state with an adhesive. In this case, both end faces 331a and 332a of the divided permanent magnets 331 and 332 in the circumferential direction are respectively abutted with and positioned by the both end faces 325a in the circumferential direction of the positioning parts 325. In this embodiment, a depth dimension of the second recessed parts 321 and 322 is substantially equal to a thickness dimension of the divided permanent magnets 331 and 332 and the second recessed parts 321 and 322 are buried with the divided permanent magnets 331 and 332.

In the rotor 3 structured as described above, the outer peripheral faces of the divided permanent magnets 331 and 332 are covered with a protective layer 39. The protective layer 39 is formed over the whole first recessed part 32a and the first recessed part 32a is covered with the protective layer 39 in a substantially complete manner.

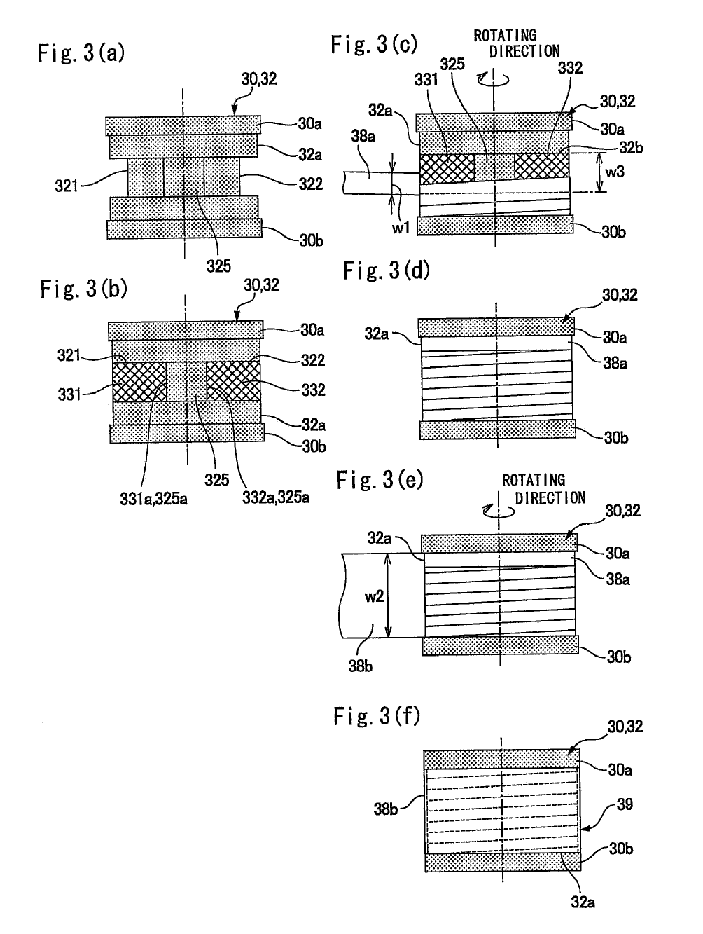

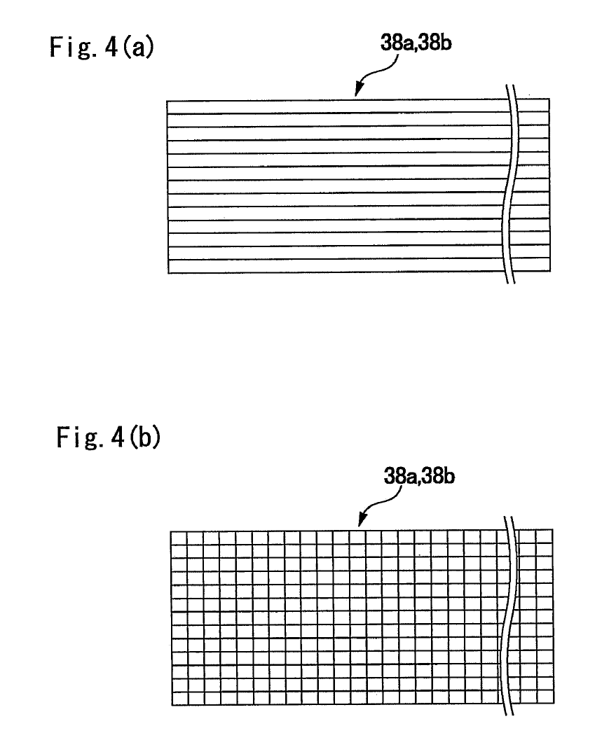

In this embodiment, as described below with reference to FIGS. 3(a) through 3(f) and FIGS. 4(a) and 4(b), the protective layer 39 is provided with a structure in which a fiber sheet is solidified with a thermosetting resin such as epoxy resin or phenol resin to prevent damage of the divided permanent magnets 331 and 332 due to a centrifugal force or to prevent from scattering of the divided permanent magnets 331 and 332 even when they have been damaged due to the centrifugal force.

With reference to FIGS. 3(a) through 3(f) and FIGS. 4(a) and 4(b), a structure of the rotor 3 and the protective layer 39 will be described in detail below while a manufacturing method for the rotor 3 is described.

FIGS. 3(a) through 3(f) are side views showing steps of a manufacturing method for the rotor 3 to which at least an embodiment of the present invention is applied. FIGS. 4(a) and 4(b) are explanatory views showing prepreg which is used to form the protective layer 39 in the rotor 3 to which at least an embodiment of the present invention is applied.

In order to manufacture the rotor 3 in this embodiment, as shown in FIG. 3(a), firstly a yoke part 32 for defining an outer peripheral face of the rotor shaft 30 in which the first recessed part 32a, the second recessed parts 321 and 322 and the positioning parts 325 are formed is prepared. Large diameter parts 30a and 30b are formed at both end portions in the yoke part 32.

Next, as shown in FIG. 3(b), divided permanent magnets 331 and 332 which have been magnetized are respectively fitted to the second recessed parts 321 and 322 and fixed to them with an adhesive. As a result, the second recessed parts 321 and 322 are buried with the divided permanent magnets 331 and 332. In other words, the outer peripheral faces of the divided permanent magnets 331 and 332 are set to be substantially the same height position as the outer peripheral face of the first shallow recessed part 32a and, as a result, a structure is obtained in which the first shallow recessed part 32a is formed between the large diameter parts 30a and 30b in the state that the divided permanent magnets 331 and 332 are buried in the second recessed parts 321 and 322.

Next, a first fiber sheet winding step shown in FIG. 3(c) is performed. In other words, the first fiber sheet 38a having a width dimension w1 is wound around over a region from a lower end of the first recessed part 32a of the yoke part 32 to its upper end. The winding direction of the first fiber sheet 38a is set in a direction opposite to a rotating direction of the rotor shaft 30 (yoke part 32).

The first fiber sheet 38a is a long film-shaped carbon prepreg having the width dimension w1 and, in this carbon prepreg, a thermosetting resin is impregnated in the carbon fiber sheet. The thermosetting resin in the carbon prepreg is in a semi-cured state and not sticky and thus workability when winding is performed is satisfactory.

Further, the width dimension w1 of the first fiber sheet 38a is narrower than a width dimension w3 in the axial direction of the divided permanent magnets 331 and 332. Therefore, when the first fiber sheet 38a is to be wound around the first recessed part 32a of the yoke part 32 over a region from its lower end to its upper end, the first fiber sheet 38a is wound around the outer peripheral faces of the divided permanent magnets 331 and 332 in a spiral manner and, in addition, the first fiber sheet 38a is set to be in a partially overlapped state each other in the widthwise direction. In other words, after the first fiber sheet 38a has been wound by one round (first round) along the lower end of the first recessed part 32a, when winding of the second round and more is to be performed, the first fiber sheet 38a is wound around the yoke part 32 in a spiral shape. In this manner, the first fiber sheet 38a is wound around the yoke part 32 so as to obliquely cross to the axial direction. As a result, the first fiber sheet 38a wound around as an “n (n≧2) turn” and the first fiber sheet 38a wound as an “(n+1) turn” are wound around so that they are overlapped on each other by a substantially ½ of the width dimension w1. Therefore, the first fiber sheet 38a is wound in two layers around the outer peripheral faces of the divided permanent magnets 331 and 332. After that, as shown in FIG. 3(d), when the first fiber sheet 38a reaches to an upper end of the first recessed part 32a, the first fiber sheet 38a is wound around one turn along the upper end of the first recessed part 32a. In this embodiment, a winding direction of the first fiber sheet 38a is set to be in an opposite direction to the rotating direction of the rotor shaft 30 (yoke part 32). Therefore, an end face of the winding end of the first fiber sheet 38a is directed to a direction opposite to the rotating direction of the rotor shaft 30.

Next, in the second fiber sheet winding step shown in FIG. 3(e), the second fiber sheet 38b having a width dimension w2 is wound a predetermined number of times, for example, in five layers, around an outer peripheral face of the first fiber sheet 38a which is wound in the first recessed part 32a. A winding direction of the second fiber sheet 38b is, similarly to the first fiber sheet 38a, set to be in an opposite direction to the rotating direction of the rotor shaft 30 (yoke part 32).

The second fiber sheet 38b is a long film-shaped carbon prepreg having a width dimension w2 and, in this carbon prepreg, similarly to the first fiber sheet 38a, a thermosetting resin is impregnated in the carbon fiber sheet. The width dimension w2 of the second fiber sheet 38b is wider than a width dimension w3 in the axial direction of the divided permanent magnets 331 and 332 and is substantially equal to the width dimension of the first recessed part 32a (spaced distance of the large diameter parts 30a and 30b). Therefore, when the outer peripheral face of the first fiber sheet 38a is covered by the second fiber sheet 38b, the second fiber sheet 38b is wound around so as to be substantially perpendicular to the axial direction.

As a result, as shown in FIG. 3(f), the first recessed part 32a is completely buried with the second fiber sheet 38b. Further, the winding direction of the second fiber sheet 38b is set to be a direction opposite to the rotating direction of the rotor shaft 30 (yoke part 32) and thus an end face of the winding end of the second fiber sheet 38b is directed to a direction opposite to the rotating direction of the rotor shaft 30.

Next, in a thermosetting step, the yoke part 32 is deaerated by vacuum suction while the first fiber sheet 38a and the second fiber sheet 38b are heated to adhere the first fiber sheet 38a to the second fiber sheet 38b. Further, the thermosetting resin impregnated in the first fiber sheet 38a and the second fiber sheet 38b is thermally hardened and thus the first fiber sheet 38a and the second fiber sheet 38b are hardened by the thermosetting resin. In this manner, the protective layer 39 is formed to completely fill up the first recessed part 32a.

In order to manufacture the rotor 3, in this embodiment, as shown in FIG. 4(a), carbon prepreg in which thermosetting resin is impregnated in a fiber sheet where carbon fibers are arranged in one direction in a rotating direction (circumferential direction) of the rotor shaft 30 is used as the first fiber sheet 38a and the second fiber sheet 38b. In accordance with an embodiment of the present invention, as shown in FIG. 4(b), carbon prepreg in which thermosetting resin is impregnated in a fiber sheet which is structured of carbon fibers extended in the rotating direction (circumferential direction) of the rotor shaft 30 and carbon fibers extended in an axial direction (longitudinal direction) are weaved in a mesh-like manner each other may be used as the first fiber sheet 38a and the second fiber sheet 38b.

The carbon prepreg in which thermosetting resin is impregnated in the fiber sheet where carbon fibers are arranged in the rotating direction (circumferential direction) of the rotor shaft 30 as shown in FIG. 4(a) is inexpensive in comparison with the carbon prepreg in which thermosetting resin is impregnated in the fiber sheet which is structured of carbon fibers extended in the rotating direction (circumferential direction) of the rotor shaft 30 and carbon fibers extended in the axial direction (longitudinal direction) in the rotor shaft 30 are weaved each other in a mesh-like manner as shown in FIG. 4(b). Further, the carbon prepreg in which thermosetting resin is impregnated in the fiber sheet where carbon fibers are arranged in one direction (rotating direction) of the rotor shaft 30 as shown in FIG. 4(a) is provided with a higher strength against the extension than the carbon prepreg in which thermosetting resin is impregnated in the fiber sheet which is structured of carbon fibers extended in the rotating direction (circumferential direction) of the rotor shaft 30 and carbon fibers extended in the axial direction (longitudinal direction) in the rotor shaft 30 are weaved each other in a mesh-like manner as shown in FIG. 4(b). In other words, in the carbon prepreg structured so that a thermosetting resin is impregnated into a fiber sheet structured of carbon fibers which are woven in a mesh-like manner as shown in FIG. 4(b), when the divided permanent magnets 331 and 332 are going to be scattered, the portion formed in the mesh-like manner may be extended both in the axial direction (longitudinal direction) and the rotating direction (circumferential direction) of the rotor shaft 30. Therefore, the divided permanent magnets 331 and 332 may be scattered from the extended portion. On the other hand, the carbon prepreg shown in FIG. 4(a) is the carbon prepreg in which a thermosetting resin is impregnated into a fiber sheet structured of carbon fibers which are arranged in one direction in the rotating direction (circumferential direction) of the rotor shaft 30. Therefore, different from the carbon prepreg shown in FIG. 4(b), the carbon fibers do not extend in the both directions and, especially, strength to the stretching in the circumferential direction is superior. Accordingly, scattering of the divided permanent magnets 331 and 332 can be prevented securely. In the carbon prepreg shown in FIG. 4(a), the carbon fibers may be split along the rotating direction (circumferential direction) of the rotor shaft 30. However, this problem can be prevented by means of that the fiber sheet for covering the outer peripheral faces of the divided permanent magnets 331 and 332 are wound around in a spiral manner to obtain the partially overlapped state in its widthwise direction and thus the carbon fibers are prevented from being split.

In the embodiment described above, the second fiber sheet 38b is wound around after the first fiber sheet 38a has been wound around the outer peripheral faces of the divided permanent magnets 331 and 332. However, the first fiber sheet 38a may be wound around after the second fiber sheet 38b has been wound around. In other words, the first fiber sheet winding step may be performed after the second fiber sheet winding step.

As described above, in the motor 1 in this embodiment, a stator with six poles in a concentrated winding system where the coil 22 is wound around each of a plurality of the salient poles 21a is used for the stator 2, and the rotor 3 is provided with a two-pole structure. In the structure as described above, when the rotor 3 is rotated, an induced voltage waveform obtained from the coil 22 may be distorted.

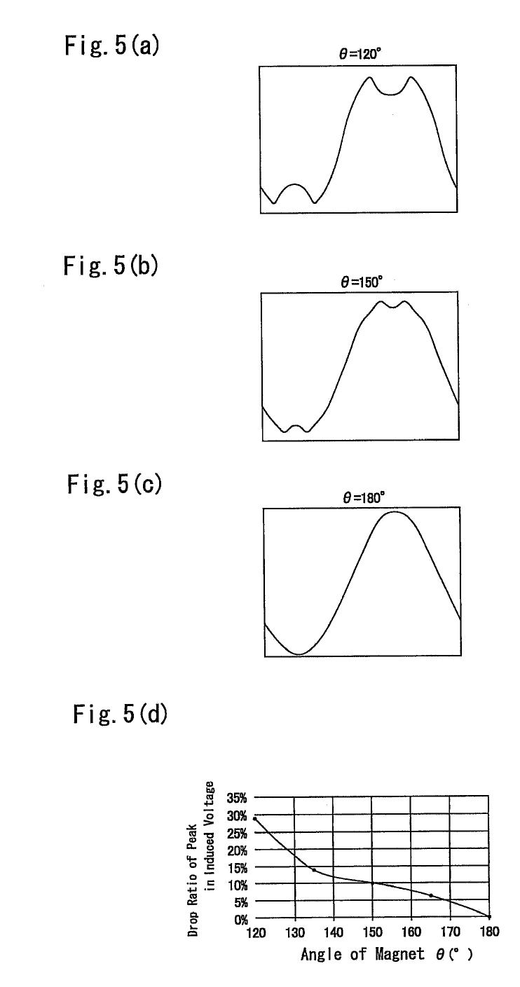

In this embodiment, on the basis of examination results described below with reference to FIGS. 5(a) through 5(d), each of the divided permanent magnets 331 and 332 are formed in a circular arc shape with a circular arc angle from 135° (included) to 180° (included), preferably from 150° (included) to 180° (included) and the circular arc angles of the divided permanent magnets 331 and 332 are equal to each other. Further, each of the divided permanent magnets 331 and 332 are magnetized over the whole region in the circumferential direction. Therefore, in this embodiment, two magnetic poles comprised of an S-pole and an N-pole in the permanent magnet 33 are respectively formed over the circular arc angle from 135° to 180°, preferably from 150° to 180°. However, in the permanent magnet 33 shown in FIG. 1 and FIG. 2(a), the circular arc angle of the divided permanent magnets 331 and 332 (angular range of the two magnetic poles comprised of the S-pole and the N-pole) is set to be less than 180°.

In accordance with an embodiment, a structure in which the circular arc angle of the divided permanent magnets 331 and 332 is set to be at 180° corresponds to a structure in which the second recessed parts 321 and 322 are continuously formed without the positioning part 325 and thus the second recessed part is formed on the whole circumference of the rotor shaft 30 in the rotor 3.

In accordance with an embodiment of the present invention, as shown in FIG. 2(b), the divided permanent magnets 331 and 332 which are magnetized over the whole portion in the circumferential direction are used for the permanent magnet 33, and the circular arc angles θ of the divided permanent magnets 331 and 332 are equal to each other. In this embodiment, a variation of induced voltage waveforms is examined when the circular arc angle θ of the divided permanent magnets 331 and 332 (angular range of the two magnetic poles in the permanent magnet 33) is changed from 120° to 180°. The results are shown in FIGS. 5(a), 5(b), 5(c) and 5(d).

FIGS. 5(a), 5(b) and 5(c) respectively show waveforms of an induced voltage when the circular arc angle θ of the divided permanent magnets 331 and 332 is set to be at 120°, 150°, and 180°, and FIG. 5(d) is a graph showing a relationship between the circular arc angle θ of the divided permanent magnets 331 and 332 and a drop ratio of the peak voltage in the induced voltage waveform.

As understood from FIGS. 5(a), 5(b), 5(c) and 5(d), the more the circular arc angle θ of the divided permanent magnets 331 and 332 is increased from 120°, 150°, 165° to 180°, the drop of the peak voltage in the induced voltage waveform becomes smaller and thus its waveform approaches a sine-wave. Therefore, when the circular arc angle θ of the divided permanent magnets 331 and 332 is set in an angular range from 135° to 180° like this embodiment, the drop of the peak voltage in the induced voltage waveform is suppressed to less than 15% and thus rotation control of the motor 1 can be surely performed even when the stator in a concentration winding system is used and the rotor 3 is provided with two magnetic poles. Further, when the circular arc angle θ of the divided permanent magnets 331 and 332 is set in an angular range from 150° to 180°, the drop of the peak voltage in the induced voltage waveform can be suppressed to less than 10%.

As described above, in this embodiment, a stator in a concentrated winding system in which the coils 22 respectively wound around a plurality of the salient poles 21a is used for the stator 2 and thus improvement of a motor characteristic, for example, reduction of an electrical resistance by shortening of coil end, can be obtained. Further, in this embodiment, the rotor 3 is set to be in a two-pole structure and two magnetic poles of the permanent magnet 33 are respectively formed over an angular range from 135° to 180°, preferably over an angular range from 150° to 180°. In other words, the region where the magnetic pole is not formed in the circumferential direction is narrow. Therefore, the drop of the peak voltage in the induced voltage waveform can be suppressed to 15% or less, or 10% or less. In this drop state, the induced voltage can be treated in the same way as a sine wave. Accordingly, even when the stator 2 in a concentrated winding system is used and the rotor 3 is structured so as to have two magnetic poles, rotation control of the motor 1 can be securely performed, and torque ripple and iron loss can be reduced.

Further, in this embodiment, since the stator 2 is formed in a six-pole structure, iron loss can be reduced and, problems such as reduction of torque, increase of cogging torque, reduction of utilization efficiency of magnetic flux of the permanent magnet can be avoided. In other words, when the number of poles is set to be more than six, iron loss becomes larger and, when the number of poles is set to be less than six, problems such as reduction of torque, increase of cogging torque, reduction of utilization efficiency of magnetic flux of the permanent magnet occur. However, when the number of poles is set to six, the above-mentioned problems can be avoided.

In addition, in this embodiment, the divided permanent magnets 331 and 332 are used for the permanent magnet 33. Therefore, an expensive sleeve made of titanium is not required to cover its outer peripheral face and thus its cost can be reduced. In other words, when a ring-shaped permanent magnet is used, the magnet may be destroyed itself by a centrifugal force at a high-speed rotation and thus an expensive sleeve made of titanium is required to cover its outer peripheral face to apply a pressure toward its inner side. However, when the divided permanent magnets 331 and 332 are used, the divided permanent magnets 331 and 332 may not be destroyed themselves by a centrifugal force even when they are rotated at a high speed. Therefore, as described with reference to FIGS. 3(a) through 3(f) and FIGS. 4(a) and 4(b), the carbon prepreg (the first fiber sheet 38a and the second fiber sheet 38b) is wound around the outer peripheral face of the divided permanent magnets 331 and 332 to form the protective layer 39 for preventing the divided permanent magnets 331 and 332 from damaging and scattering. Accordingly, steps are eliminated in which, after a protective cover such as an expensive cylindrical sleeve made of titanium has been formed, the protective cover is fitted or press-fitted to the outer periphery of the permanent magnets, and a finish machining for enhancing accuracy of an inner diameter of the protective cover is eliminated.

In this embodiment, the first fiber sheet 38a having a narrow width and the second fiber sheet 38b having a wide width are wound around plural times and thus strength of the protective layer 39 is large. Therefore, scattering of the divided permanent magnets 331 and 332 can be prevented securely and the divided permanent magnets 331 and 332 are securely fixed to the rotor shaft 30 by the protective layer 39.

Further, the first fiber sheet 38a having a narrow width is wound around spirally and the second fiber sheet 38b having a wide width is wound around so as to cover the entire in the widthwise direction. In other words, winding can be performed depending on a width dimension of the fiber sheet. Therefore, the protective layer 39 with a large strength can be formed efficiently.

Further, the carbon prepreg (the first fiber sheet 38a and the second fiber sheet 38b) is wound around the outer peripheral face of the divided permanent magnets 331 and 332 to form the protective layer 39. Therefore, even when a winding face of the first fiber sheet 38a and the second fiber sheet 38b are formed on an inner side in the radial direction of the outer peripheral faces of a pair of the large diameter parts 30a and 30b which are formed on both end sides so as to interpose the holding positions for the divided permanent magnets 331 and 332, the first fiber sheet 38a and the second fiber sheet 38b can be wound around. On the other hand, as a comparison example, in a case that, after a cylindrical protective cover has been formed, the protective cover is fitted or press-fitted to the outer periphery of permanent magnets, when the large diameter parts 30a and 30b are formed on both end sides so as to interpose the holding positions for the divided permanent magnets 331 and 332, the cylindrical protective cover cannot be fitted to the rotor shaft to cover the permanent magnets. However, according to this embodiment, even when the rotor 3 having the above-mentioned structure is used, the outer peripheral face of the permanent magnets can be covered with the protective layer 39. This effect can be obtained even when one kind of carbon prepreg is wound around the outer peripheral faces of the divided permanent magnets 331 and 332 to form the protective layer 39.

Further, in this embodiment, the first fiber sheet 38a is wound around in a spiral manner. Therefore, the first fiber sheet 38a is easily wound around the outer peripheral faces of the divided permanent magnets 331 and 332 in the state where the first fiber sheet 38a is partially overlapped with each other in the widthwise direction.

Further, in this embodiment, carbon prepreg in which thermosetting resin is impregnated to a carbon fiber sheet is used for the first fiber sheet 38a and the second fiber sheet 38b. Therefore, the thermosetting resin can be rigidified only by heating after being wound around. Accordingly, since resin is not required to be impregnated after winding, the protective layer 39 can be formed efficiently.

Further, in this embodiment, as shown in FIG. 4(a), carbon prepreg in which the thermosetting resin is impregnated in the carbon fiber sheet whose forming direction of fiber is arranged in only one direction is used for the first fiber sheet 38a and the second fiber sheet 38b. The carbon prepreg having this structure is inexpensive in comparison with carbon prepreg shown in FIG. 4(b). Therefore, since the protective layer 39 can be manufactured at a low cost, a manufacturing cost of the rotor 3 can be reduced. In this embodiment, the carbon prepreg in which the thermosetting resin is impregnated in the carbon fiber sheet whose forming direction of fiber is arranged in only one direction may split along an extending direction of the fiber. However, according to this embodiment, the first fiber sheet 38a and the second fiber sheet 38b are wound around plural times and thus the split can be prevented. Further, since the first fiber sheet 38a is wound around in a spiral manner, fibers may intersect each other even when the carbon prepreg in which the thermosetting resin is impregnated in the carbon fiber sheet whose forming direction of fiber is arranged in only one direction. Therefore, the protective layer 39 which is hard to be split and which is provided with a high degree of strength can be formed.

In addition, in this embodiment, the winding direction of the second fiber sheet 38b which is wound around the outer peripheral side is the opposite direction to the rotating direction of the rotor shaft 30 (yoke part 32). Therefore, the end face of the winding end of the second fiber sheet 38b faces toward a direction opposite to the rotating direction of the rotor shaft 30. Accordingly, when the rotor shaft 30 is rotated, the end part of the winding end is not rolled up by a wind pressure.

In addition, the divided permanent magnets 331 and 332 are fitted to the second recessed parts 321 and 322 formed on the outer peripheral face of the rotor shaft 30, and the depth dimension of the second recessed part 322 is set to be substantially equal to the thickness dimension of the divided permanent magnets 331 and 332. Therefore, the protective layer 39 can be formed in the state that the divided permanent magnets 331 and 332 are completely embedded in the second recessed part 322 and thus fixing and prevention of scattering of the divided permanent magnets 331 and 332 can be performed securely.

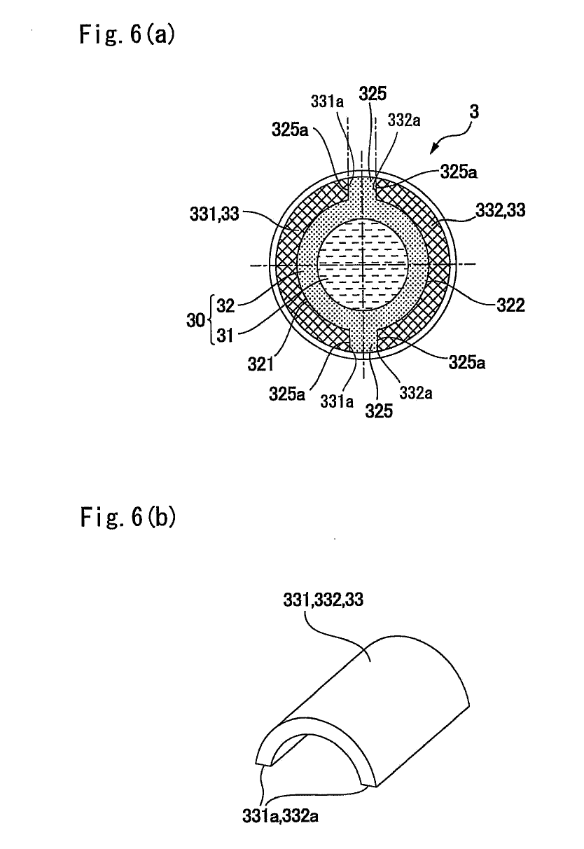

In the embodiment described above, both end faces 331a and 332a in the circumferential direction of the divided permanent magnets 331 and 332 are formed in a radial direction with respect to the center of the rotor 3. However, as shown in FIGS. 6(a) and 6(b), end faces 331a and 332a which are located at both end portions in the circumferential direction of the respective two divided permanent magnets 331 and 332 may be preferably formed on the same plane. According to the structure as described above, the divided permanent magnets 331 and 332 can be formed efficiently. Further, the divided permanent magnets 331 and 332 can be stably placed in a state where their end faces located at both end portions face in a downward direction and thus the divided permanent magnets 331 and 332 are easily handled in manufacturing steps. Further, in the state where the divided permanent magnets 331 and 332 are disposed on the rotor 3, the end faces 331a and 332a of the divided permanent magnets 331 and 332 are parallel to each other and thus the divided permanent magnets 331 and 332 can be held on the rotor 3 with a high degree of positional accuracy.

In the embodiment described above, the divided permanent magnets 331 and 332 are used for the permanent magnet 33. However, the present invention may be applied to a case that two magnetic poles of an “S”-pole and an “N”-pole are anisotropicly magnetized in one cylindrical magnetic member structuring a permanent magnet. In other words, two magnetic poles of the cylindrical permanent magnet 33 are respectively formed over an angular range from 135° to 180°, preferably over an angular range from 150° to 180°.

In the embodiment described above, the outer peripheral face of the permanent magnet 33 is covered by the protective layer 39 which is comprised of the prepreg. However, the present invention may be applied to a motor whose outer peripheral face is covered with a sleeve made of titanium.

### Second Embodiment

Next, a motor to which at least an embodiment of the present invention is applied, a rotor which is mounted on the motor, and a manufacturing method for the rotor will be described below with reference to the accompanying drawings. The second embodiment is an embodiment to which the second invention is applied.

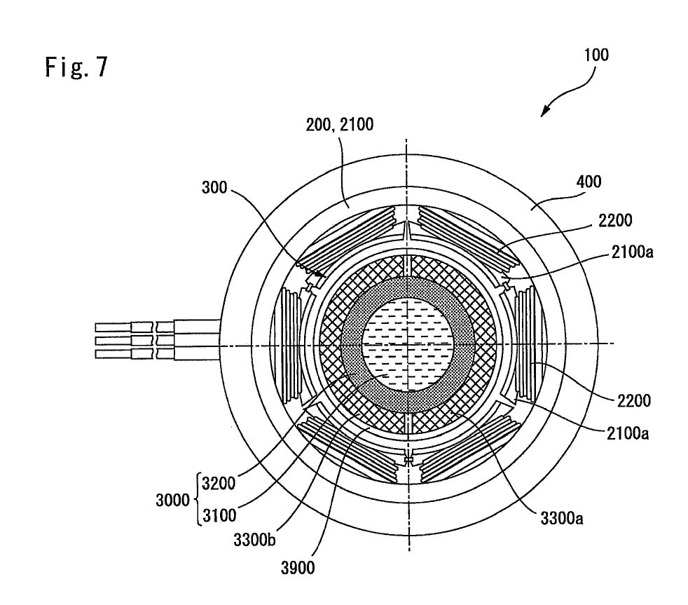

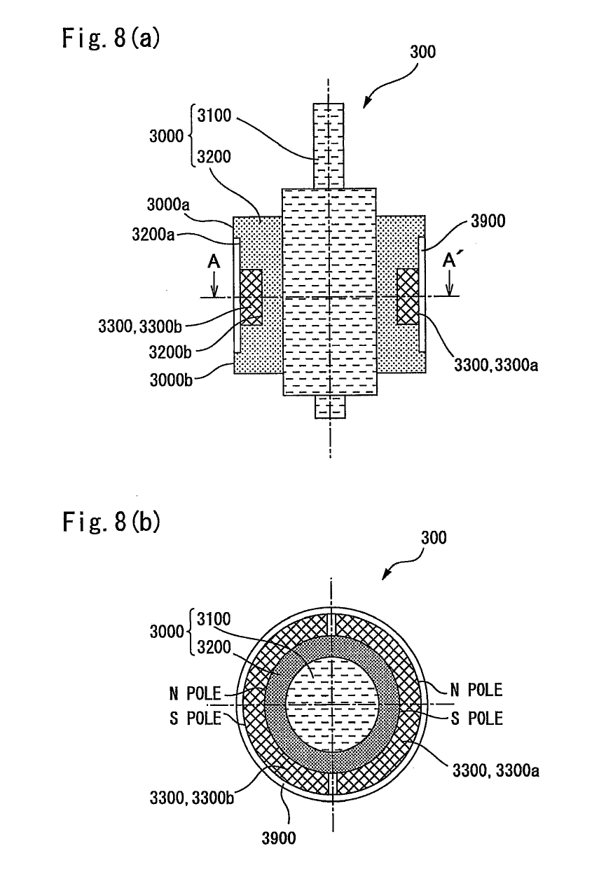

FIG. 7 is a plan view showing a structure of a motor in accordance with a second embodiment of the present invention. FIG. 8(a) is a longitudinal sectional view showing a rotor in accordance with the second embodiment of the present invention and FIG. 8(b) is an “A-A′” cross-sectional view in FIG. 8(a).

As shown in FIG. 7, a motor 100 in this embodiment is an inner rotor-type motor in which a rotor 300 is disposed on an inner side of a ring-shaped stator 200, and the stator 200 and the rotor 300 are accommodated in a case 400.

The stator 200 includes a ring-shaped stator core 2100 and the stator core 2100 is provided with six salient poles 2100a protruding on an inner side in a radial direction. A coil 2200 is wound around each of the six salient poles 2100a to structure a six pole stator in a concentrated winding type. The stator 200 generates a rotating magnetic field to the rotor 300.

As shown in FIG. 7 and FIGS. 8(a) and 8(b), the rotor 300 includes a rotor shaft 3000 and permanent magnets 3300a and 3300b which are held on an outer peripheral face of the rotor shaft 3000. The outer peripheral face of the rotor 300 faces the salient poles 2100a provided in the stator 200 through a predetermined gap space.

The rotor shaft 3000 includes a shaft body 3100 whose both ends are supported by bearings (not shown) and a yoke part 3200 which is formed on an outer periphery of the shaft body 3100.

The permanent magnets 3300a and 3300b are structured of two permanent magnets 3300a and 3300b (divided magnet) whose cross section is a semicircular arc shape. An outer side of one of the permanent magnets 3300a and 3300b is magnetized in an “N”-pole and an outer side of the other permanent magnet is magnetized in an “S”-pole.

As shown in FIG. 8(a), an outer peripheral face of the rotor shaft 3000 (outer peripheral face of the yoke part 3200) is formed with a first shallow recessed part 3200a, which is shallower than a second recessed part 3200b described below, so as to extend in a circumferential direction over a wide area in an axial direction at a middle position in a longitudinal direction of the rotor shaft 3000. Large diameter parts 3000a and 3000b having the same diameter each other are formed at both ends in the axial direction of the yoke part 3200.

Further, the second recessed part 3200b extended in the circumferential direction is formed at a substantially center portion in the axial direction of the first recessed part 3200a so as to be deeper than the first recessed part 3200a. The permanent magnets 3300a and 3300b are fitted into the second recessed part 3200b. In this embodiment, since a depth dimension of the second recessed part 3200b is substantially equal to a thickness dimension of the permanent magnets 3300a and 3300b, the second recessed part 3200b is buried with the permanent magnets 3300a and 3300b.

In the rotor 300 structured as described above, outer peripheral faces of the permanent magnets 3300a and 3300b are covered with a protective layer 3900. In this embodiment, the protective layer 3900 is formed over the whole first recessed part 3200a and the first recessed part 3200a is substantially completely buried with the protective layer 3900.

In this embodiment, similarly to the first embodiment describing the first invention with reference to FIGS. 3(a) through 3(f) and FIGS. 4(a) and 4(b), the protective layer 3900 is provided with a structure in which a fiber sheet is hardened with a thermosetting resin such as epoxy resin or phenol resin. Therefore, the permanent magnets 3300a and 3300b are prevented from being damaged due to a centrifugal force and, even when the permanent magnets 3300a and 3300b have been damaged by a centrifugal force, the permanent magnets 3300a and 3300b are prevented from being scattered.

A manufacturing method for the rotor 300 to which at least an embodiment of the present invention is applied is the same as that for the rotor in accordance with the first embodiment of the first invention which have been described with reference to FIGS. 3(a) through 3(f) and FIGS. 4(a) and 4(b). This embodiment is different from the first embodiment in a point where the positioning part is not formed in the rotor shaft 3000 but other structures are the same and thus the detailed description of the manufacturing method for the rotor 300 is omitted. In the following descriptions, the first fiber sheet and the second fiber sheet common to the first invention are described with the notational symbols which are used in the first invention.

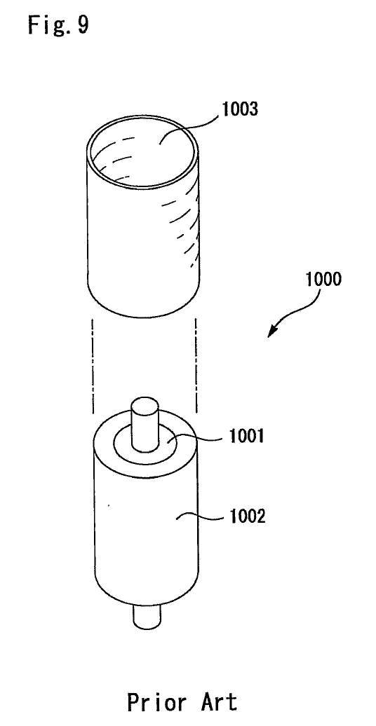

Also in the second embodiment, the carbon prepreg (the first fiber sheet 38a and the second fiber sheet 38b) is wound around the outer peripheral faces of the permanent magnets 3300a and 3300b to form the protective layer 3900 for preventing damage and scattering of the permanent magnets 3300a and 3300b. Therefore, different from the structure described with reference to FIG. 9, a manufacturing step can be eliminated in which a pipe-shaped protective cover is fitted or press-fitted to the outer periphery of the permanent magnet after the protective cover has been formed by using a dummy member. Further, finish machining for enhancing accuracy of the inner diameter of the protective cover can be eliminated. Therefore, according to this embodiment, manufacturing efficiency of the rotor 300 can be enhanced.

Further, in this embodiment, the first fiber sheet 38a having a narrow width and the second fiber sheet 38b having a wide width are wound around plural times and thus strength of the protective layer 3900 is large. Therefore, scattering of the divided permanent magnets 3300a and 3300b can be prevented securely and the divided permanent magnets 3300a and 3300b are securely fixed to the rotor shaft 3000 by the protective layer 3900. Further, the first fiber sheet 38a having a narrow width is wound around spirally and the second fiber sheet 38b having a wide width is wound around to cover the whole widthwise direction, in other words, winding can be performed depending on a width dimension of the fiber sheet. Therefore, the protective layer 3900 having a large strength can be formed efficiently.

Further, the carbon prepreg (the first fiber sheet 38a and the second fiber sheet 38b) is wound around the outer peripheral faces of the permanent magnets 3300a and 3300b to form the protective layer 39. Therefore, even when a winding face for the first fiber sheet 38a and the second fiber sheet 38b are formed on an inner side in the radial direction of the outer peripheral faces of a pair of the large diameter parts 3000a and 3000b which are formed on both end sides so as to interpose the holding portion for the permanent magnets 3300a and 3300b, the first fiber sheet 38a and the second fiber sheet 38b can be wound around. On the other hand, as a comparison example, in the structure described with reference to FIG. 9, if the large diameter parts 3000a and 3000b are formed on both end sides so as to interpose the holding portion for the permanent magnets 3300a and 3300b, the cylindrical protective cover cannot be fitted to the rotor shaft to cover the permanent magnets. However, according to this embodiment, even when the rotor 300 having the above-mentioned structure is used, the outer peripheral face of the permanent magnets can be covered with the protective layer 3900. This effect can be obtained even when one kind of carbon prepreg is wound around the outer peripheral faces of the permanent magnets 3300a and 3300b to form the protective layer 3900.

Further, in this embodiment, the first fiber sheet 38a is wound around in a spiral manner. Therefore, the first fiber sheet 38a is easily wound around the outer peripheral faces of the permanent magnets 3300a and 3300b in the state where the first fiber sheet 38a is partially overlapped with each other in the widthwise direction.

Further, in this embodiment, carbon prepreg in which thermosetting resin is impregnated to a carbon fiber sheet is used for the first fiber sheet 38a and the second fiber sheet 38b. Therefore, the thermosetting resin can be rigidified only by heating after being wound around. Accordingly, since resin is not required to be impregnated after winding, the protective layer 3900 can be formed efficiently. Further, the carbon prepreg is superior in adhesivity with the permanent magnets 3300a and 3300b and with the large diameter parts 3000a and 3000b.

Further, in this embodiment, as shown in FIG. 4(a), carbon prepreg in which the thermosetting resin is impregnated in the carbon fiber sheet whose forming direction of fiber is arranged in only one direction in the rotating direction (circumferential direction) of the rotor shaft 3000 is used for the first fiber sheet 38a and the second fiber sheet 38b. The carbon prepreg having this structure is inexpensive in comparison with carbon prepreg shown in FIG. 4(b) in which carbon fibers extended in the rotating direction (circumferential direction) of the rotor shaft 3000 and carbon fibers extended in the axial direction (longitudinal direction) of the rotor shaft 3000 are woven each other in a mesh-like shape. Therefore, since the protective layer 3900 can be manufactured at a low cost, a manufacturing cost of the rotor 300 can be reduced. Further, the carbon prepreg which is structured as shown in FIG. 4(a) is provided with a higher strength for elongation in comparison with carbon prepreg shown in FIG. 4(b) and thus scattering of the permanent magnets 3300a and 3300b can be prevented securely. In this embodiment, the carbon prepreg in which the thermosetting resin is impregnated in the carbon fiber sheet whose forming direction of fiber is arranged in only one direction may split along the extending direction of the fiber. However, according to this embodiment, the first fiber sheet 38a and the second fiber sheet 38b are wound around plural times and thus the split can be prevented. Further, since the first fiber sheet 38a is wound around in a spiral manner, fibers may intersect each other even when the carbon prepreg in which the thermosetting resin is impregnated in the carbon fiber sheet whose forming direction of fiber is arranged in only one direction. Therefore, the protective layer 3900 which is hard to be split and which is provided with a high degree of strength can be formed.

In addition, in this embodiment, the winding direction of the second fiber sheet 38b which is wound around the outer peripheral side is the opposite direction to the rotating direction of the rotor shaft 3000 (yoke part 3200). Therefore, the end face of the winding end of the second fiber sheet 38b faces toward a direction opposite to the rotating direction of the rotor shaft 3000. Accordingly, when the rotor shaft 3000 is rotated, the end part of the winding end is not rolled up by a wind pressure.

In addition, in this embodiment, the first fiber sheet 38a is wound around on a lower side (inner side) and the second fiber sheet 38b is wound around on an upper side (outer side) of the first fiber sheet 38a. According to the structure as described above, routes for air or the like entering from the outside into a space between the first fiber sheet 38a and the second fiber sheet 38b can be reduced and thus the end part of the winding end is not rolled up, for example, by a wind pressure. Further, unevenness in the outer peripheral face of the protective layer 3900 can be also eliminated.

In addition, the permanent magnets 3300a and 3300b are fitted to the second recessed part 3200b formed on the outer peripheral face of the rotor shaft 3000, and the depth dimension of the second recessed part 3200b is set to be substantially equal to the thickness dimension of the permanent magnets 3300a and 3300b. Therefore, the protective layer 3900 can be formed in the state that the permanent magnets 3300a and 3300b are completely embedded in the second recessed part 3200b and thus fixing, moving restriction in the axial direction and prevention of scattering of the permanent magnets 3300a and 3300b can be performed securely. Further, according to the structure as described above, a step difference is not formed between the first recessed part 3200a and the permanent magnets 3300a and 3300b and thus the fiber sheets 38a and 38b can be wound around the outer peripheral face of the rotor shaft 3000 without a step difference. Therefore, the protective layer 3900 with a large strength can be formed efficiently.

In the embodiment described above, the second fiber sheet 38b is wound around after the first fiber sheet 38a has been wound around the outer peripheral faces of the permanent magnets 3300a and 3300b. However, the first fiber sheet 38a may be wound around after the second fiber sheet 38b has been wound around. In other words, the first fiber sheet winding step may be performed after the second fiber sheet winding step.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a stator which is provided with a plurality of salient poles protruding radially and coils wound around a plurality of the salient poles; and
a rotor which is provided with a permanent magnet facing tip ends of the salient poles through a gap space;
wherein the stator is a stator in a concentrated winding system in which the coils are respectively wound around a plurality of the salient poles, the permanent magnet is structured of two magnetic poles which are provided with one “S”-pole and one “N”-pole, and each of the two magnetic poles is formed in an angular range of from 135° to 180° and the two magnetic poles are formed in a same angular range to each other.

2. The motor according to claim 1, wherein the stator is structured with six poles having six salient poles.

3. The motor according to claim 1, wherein each of the two magnetic poles is formed in an angular range from 150° to 180°.

4. The motor according to claim 1, wherein the permanent magnet is comprised of two divided permanent magnets which are divided into two poles in a circumferential direction.

5. The motor according to claim 4, wherein the two divided permanent magnets are formed in a circular arc shape whose circular arc angle is less than 180°.

6. The motor according to claim 5, wherein the rotor is formed with a positioning part with which end faces in the circumferential direction of the two divided permanent magnets abut.

7. The motor according to claim 6, wherein
the rotor is provided with a rotor shaft which holds the two divided permanent magnets on an outer peripheral face of the rotor shaft;
the outer peripheral face of the rotor shaft is formed with two recessed parts for fitting the two divided permanent magnets;
a portion of the rotor shaft which is sandwiched by the two recessed parts is formed as the positioning part; and
both end faces in the circumferential direction of the positioning part are abutted with end faces in the circumferential direction of the two divided permanent magnets.

8. The motor according to claim 7, wherein
a depth dimension of the recessed part is substantially equal to a thickness dimension of the two divided permanent magnets; and
a shallow recessed part is formed in the circumferential direction on both sides in an axial direction of the recessed part so as to be shallower than the recessed part; and
a protective layer for protecting outer peripheral faces of the two divided permanent magnets is formed over a whole of the shallow recessed part.

9. The motor according to claim 4, wherein each of the two divided permanent magnets is provided with end faces in the circumferential direction which are located on a same plane.

10. The motor according to claim 4, wherein the two divided permanent magnets are magnetized over a whole circumferential direction.

11. The motor according to claim 1, wherein an outer peripheral side of the permanent magnet is covered with a protective layer.

12. The motor according to claim 11, wherein the protective layer includes a fiber sheet which is hardened with resin.

13. A rotor comprising:
a rotor shaft;
a permanent magnet which is held on an outer periphery of the rotor shaft; and
a protective layer which includes a fiber sheet hardened with resin for covering an outer peripheral side of the permanent magnet;
wherein the fiber sheet comprises:
a first fiber sheet whose width dimension is narrower than a width dimension in an axial direction of the permanent magnet; and
a second fiber sheet which is provided with a width dimension equal to or more than a width dimension in the axial direction of the permanent magnet; and
wherein the first fiber sheet and the second fiber sheet are wound around the outer peripheral side of the permanent magnet so as to overlap each other.

14. The rotor according to claim 13, wherein the first fiber sheet is wound around so that the first fiber sheet is partially overlapped each other in a widthwise direction.

15. The rotor according to claim 14, wherein the first fiber sheet is wound around in a spiral manner.

16. The rotor according to claim 13, wherein a winding end face of at least one of the first fiber sheet and the second fiber sheet, which is disposed on an outer side, is directed to a direction opposite to a rotating direction of the rotor shaft.

17. The rotor according to claim 13, wherein the first fiber sheet is wound around an inner side and the second fiber sheet is wound around on an outer side of the first fiber sheet.

18. The rotor according to claim 13, wherein the second fiber sheet is wound around on an inner side and the first fiber sheet is wound around on an outer side of the second fiber sheet.

19. The rotor according to claim 13, wherein
the rotor shaft is formed with a pair of large diameter parts at both end sides so as to interpose a holding portion of the permanent magnet, and
a winding face for the fiber sheet of the protective layer is located on an inner side in a radial direction with respect to outer peripheral faces of the pair of the large diameter parts.

20. The rotor according to claim 19, wherein the second fiber sheet is provided with a width dimension which is substantially equal to a separated dimension of the pair of the large diameter parts.

21. The rotor according to claim 13, wherein the permanent magnet is fitted into a recessed part which is formed on an outer peripheral face of the rotor shaft.

22. The rotor according to claim 21, wherein a depth dimension of the recessed part is substantially equal to a thickness dimension of the permanent magnet.

23. The rotor according to claim 22, wherein
a shallow recessed part which is shallower than the recessed part is formed on both sides in an axial direction of the recessed part over a whole circumferential direction, and
the first fiber sheet and the second fiber sheet are wound around the whole shallow recessed part so as to cover the outer periphery of the permanent magnet.

24. The rotor according to claim 13, wherein the first fiber sheet and the second fiber sheet include carbon fibers.

25. The rotor according to claim 24, wherein all fibers in at least one of the first fiber sheet and the second fiber sheet are arranged in one direction in a rotating direction of the rotor shaft.

26. The rotor according to claim 24, wherein each of the first fiber sheet and the second fiber sheet is comprised of prepreg in which the resin is impregnated.

27. A manufacturing method for a rotor which is provided with a rotor shaft and a permanent magnet held on an outer periphery of the rotor shaft comprising:
a first fiber sheet winding step in which a first fiber sheet whose width dimension is narrower than a width dimension in an axial direction of the permanent magnet is wound around an outer peripheral side of the permanent magnet; and
a second fiber sheet winding step, which is performed before or after the first fiber sheet winding step, and in which a second fiber sheet whose width dimension is equal to or more than the width dimension in the axial direction of the permanent magnet is wound around the outer peripheral side of the permanent magnet;
thereby the outer peripheral side of the permanent magnet is covered with a protective layer in which the fiber sheet is hardened with resin.

28. The manufacturing method for a rotor according to claim 27, wherein
prepreg is used for the first fiber sheet and the second fiber sheet, and
a thermosetting step in which resin included in the prepreg is heated to be hardened is performed after the first fiber sheet winding step and the second fiber sheet winding step.

29. A motor comprising:
a rotor comprising:
a rotor shaft;
a permanent magnet which is held on an outer periphery of the rotor shaft; and
a protective layer which includes a fiber sheet hardened with resin for covering an outer peripheral side of the permanent magnet;
wherein the fiber sheet comprises:
a first fiber sheet whose width dimension is narrower than a width dimension in an axial direction of the permanent magnet; and
a second fiber sheet which is provided with a width dimension equal to or more than a width dimension in the axial direction of the permanent magnet; and
wherein the first fiber sheet and the second fiber sheet are wound around the outer peripheral side of the permanent magnet so as to overlap each other; and
a stator for generating a rotating magnetic field to the rotor.

30. The motor according to claim 29, wherein the first fiber sheet is wound around an inner side and the second fiber sheet is wound around on an outer side of the first fiber sheet.

31. The motor according to claim 29, wherein
the rotor shaft is formed with a pair of large diameter parts at both end sides so as to interpose a holding portion of the permanent magnet, and
a winding face for the fiber sheet of the protective layer is located on an inner side in a radial direction with respect to outer peripheral faces of a pair of the large diameter parts.
